(19) United States
(12) Patent Application Publication
(10) Pub. No.: US 2011/0115417 A1
(43) Pub. Date: May 19, 2011

(54) PM MOTOR DRIVE POWER SUPPLY APPARATUS

(75) Inventor: Ryuichi Shimada, Tokyo (JP)

(73) Assignee: MERSTech INC., Tokyo (JP)

(21) Appl. No.: 13/000,347

(22) PCT Filed: Jun. 27, 2008
(86) PCT No.: PCT/JP2008/062122

§ 371 Date: Jan. 24, 2011

(51) Int. Cl. H02P 6/00

(52) U.S. Cl. 318/139

(57) ABSTRACT

The present invention provides a PM motor drive power supply apparatus which drives a three-phase permanent-magnet synchronous motor by utilizing a direct-current power source 1, wherein control means 7 controls to simultaneously perform ON/OFF operation of a diagonally positioned pair among reverse conductive semiconductor switches (S1 to S4) of pulse voltage generating means 2, controls to perform ON/OFF operation of switches of three lines of polarity switching means 5 in turns at the same timing as the reverse conductive semiconductor switches (S1 to S4) of the pulse voltage generating means 2, selects a switch of the polarity switching means 5 based on the rotational position signal, converts direct-current pulse output of the pulse voltage generating means 2 into polarities of the three-phase alternating-current, and supplies to a PM motor 4 as drive current.

### TECHNICAL FIELD

The present invention relates to a synchronous motor drive power supply apparatus to drive a synchronous motor with a direct-current power source, in particular, relates to a synchronous motor drive power supply apparatus relevant to drive of a permanent-magnet synchronous motor at higher voltage than power voltage with a battery using a magnetic energy recovery switch.

### BACKGROUND ART

In a motor, counter-electromotive force is generated being proportional to the rotational speed being similar to a generator. Therefore, in the case of driving the motor with a voltage source, power voltage is required to be heightened in proportional to the rotational speed to provide current against the counter-electromotive force.

In order to drive a motor at high speed, the voltage of a voltage source is required to be heightened in the case of a typical voltage-type inverter. Hence, there has been a problem that a capacitor of the voltage source becomes large in electrostatic capacitance and physical size. A current-type inverter without a voltage source capacitor has large snubber power generated at the time of current interruption by a switching element and the efficiency thereof is decreased depending on how the snubber power is processed.

Meanwhile, in a thyristor motor driving with a large capacity thyristor converter over 10,000 kW, since voltage is generated at a motor side, current-type driving of a natural commutation type has been actualized and soft switching has been actualized for switch ON/OFF operation.

As a recently-developed permanent-magnet synchronous motor for an electric automobile, necessary torque is required in all speed ranges. High voltage and large current therewith are both required in the high speed range of the permanent-magnet synchronous motor.

In order to obtain high voltage required for the high speed range of the permanent-magnet synchronous motor, a system to supply boosted voltage to the permanent-magnet synchronous motor by connecting a DC-up converter to the voltage source has been employed.

In addition, there has been a case to employ a drive method called field weakening drive in the high speed range of the permanent-magnet synchronous motor. The field weakening drive is a method to perform driving in the high speed range of the permanent-magnet synchronous motor without changing the voltage of the voltage source with a magnetic field weakened by providing reactive current. However, this method is undeniable that the efficiency thereof drops.

Peaked output in short time and reduction in size and weight have been required for the permanent-magnet synchronous motor for electric automobile use and a synchronous motor drive power supply apparatus satisfying the requirement has been desired.

Further, a high-voltage layered battery used for an electric automobile has a problem of performance deterioration and a risk of electric shock and the like. Accordingly, there has been a desire to use a number of low-voltage batteries connected in parallel.

### SUMMARY OF THE INVENTION

### Problems to be Solved by the Invention

The present invention has been made in the light of the circumstances as described above, and an object of the present invention is to provide a synchronous motor drive power supply apparatus relevant to drive of a permanent-magnet synchronous motor at higher voltage than power voltage with a battery using a magnetic energy recovery switch.

### Means for Solving the Invention

The present invention relates to a synchronous motor drive power supply apparatus which drives a synchronous motor having N pieces of phases (N is a positive integer being three or larger) by utilizing a direct-current power source 1, and the object of the present invention is achieved by the synchronous motor drive power supply apparatus including pulse voltage generating means 2 which includes four reverse conductive semiconductor switches S1 to S4 mutually connected as a bridge and a capacitor 9 connected to direct-current output terminals (c, d) of the bridge to recover and store magnetic energy in the form of electrostatic energy possessed by electric charge, a reactor 3 which is connected in series to the direct-current power source 1 and alternating-current input terminals (a, b) of the bridge, polarity switching means 5 which is connected to the direct-current output terminals (c, d) of the pulse voltage generating means 2 and supplies direct-current pulse voltage generated at the capacitor 9 of the pulse voltage generating means 2 to the synchronous motor 4 as alternating-current by switching for each phase of the synchronous motor 4, a smoothing inductor 8 to smooth output of the polarity switching means 5, a rotational position sensor 6 to detect a rotational position of the synchronous motor 4 and to output a rotational position signal, and control means 7, wherein the control means 7 controls to simultaneously turn on and off one of two pairs among the reverse conductive semiconductor switches S1 to S4 of the pulse voltage generating means 2, with each pair constituted with two not-adjacent connection positioned reverse conductive semiconductor switches, selects 2N pieces of switch elements of N lines of the polarity switching means 5 based on the rotational position signal, performs ON/OFF control at the same timing as ON/OFF operation of the one pair of reverse conductive semiconductor switches of the pulse voltage generating means 2, converts the direct-current pulse voltage into current polarities of the N-phase alternating-current, and supplies to the synchronous motor 4 as drive current.

In addition, the object of the present invention is effectively achieved by the synchronous motor drive power supply apparatus, wherein ON/OFF period of the reverse conductive semiconductor switches S1 to S4 is set to be longer than a resonance period which is determined by electrostatic capacitance of the capacitor 9 and inductance of the reactor 3.

Further, the object of the present invention is effectively achieved by the synchronous motor drive power supply apparatus, wherein the switch element of the polarity switching means 5 is the reverse conductive semiconductor switch.

Still further, the object of the present invention is effectively achieved by the synchronous motor drive power supply apparatus, wherein plural sets are connected in parallel, each set being constituted with the direct-current power source 1, the pulse voltage generating means 2, and the reactor 3.

### BRIEF DESCRIPTION OF THE DRAWINGS

FIG. 1 is a circuit diagram of a first embodiment of the present invention.

FIG. 2 is a circuit diagram of assistance in explaining operation of a first embodiment of the present invention.

FIG. 3 shows gate signals of reverse conductive semiconductor switches S2 and S4 to S8 of FIG. 2. Gates not indicated are in an OFF-state.

FIG. 4 is a graph indicating a simulation result of the circuit of FIG. 2.

FIG. 5 is a diagram of a second embodiment of the present invention.

FIG. 6 is a diagram illustrating details of a simulation circuit diagram of the second embodiment.

FIG. 7 is a graph indicating a simulation result of the circuit of FIG. 5.

### BEST MODE FOR CARRYING OUT THE INVENTION

In a synchronous motor drive power supply apparatus according to the present invention, a magnetic energy recovery switch (hereinafter, called an MERS) is used for generating direct-current pulse voltage. In the MERS, voltage required for reactance is automatically generated at a capacitor in the MERS. Accordingly, there arises a feature that power voltage is not required to additionally include voltage for reactance.

When direct-current pulse voltage higher than power voltage is generated by utilizing pulse voltage generating means with an MERS and is supplied to a synchronous motor via polarity switching means, necessary voltage and current in a high speed range can be obtained. Accordingly, the synchronous motor provides high speed and high power (i.e., high torque). In the synchronous motor drive power supply apparatus according to the present invention, the pulse voltage generating means with an MERS is applied for a synchronous motor drive power supply apparatus.

Counter-electromotive force becomes large in the high speed range of the motor. The power source is required to provide current to the motor against the high voltage of the counter-electromotive force. In the synchronous motor drive power supply apparatus according to the present invention, first, direct-current pulse voltage is generated according to a phase of the counter-electromotive force of the synchronous motor.

More specifically, the pulse voltage generating means with an MERS is constituted with four bridge-connected reverse conductive semiconductor switches, and a capacitor which stores magnetic energy in the form of electrostatic energy possessed by electric charge (hereinafter, called a capacitor).

With the pulse voltage generating means with an MERS with which a reactor is combined, the voltage required for the reactance of the circuit can be automatically generated at the capacitor due to ON/OFF operation of the reverse conductive semiconductor switch with low power voltage.

When the voltage generated at the capacitor is applied to the synchronous motor, using the reverse conductive semiconductor switches as the switch elements of the polarity switching means, the switch elements of the polarity switching means perform ON/OFF operation in synchronization with the reverse conductive semiconductor switches constituting the pulse voltage generating means with an MERS.

By the above operation, magnetic energy stored in the inductance of the synchronous motor connected to the polarity switching means is recovered as electrostatic energy possessed by electric charge to the capacitor constituting the pulse voltage generating means with an MERS. As a result, higher voltage than power voltage is generated at the capacitor.

It is a feature of the synchronous motor drive power supply apparatus according to the present invention to switch on and off the switch elements of the polarity switching means in synchronization with the reverse conductive semiconductor switches constituting the pulse voltage generating means. In the above manner, output can be doubled.

In the following description, the MERS and the pulse voltage generating means denote the same. However, here, “the MERS” is to be used in structural description (circuit structure) and “the pulse voltage generating means” is to be used in functional description. In addition, the present invention will be described with reference to the drawings.

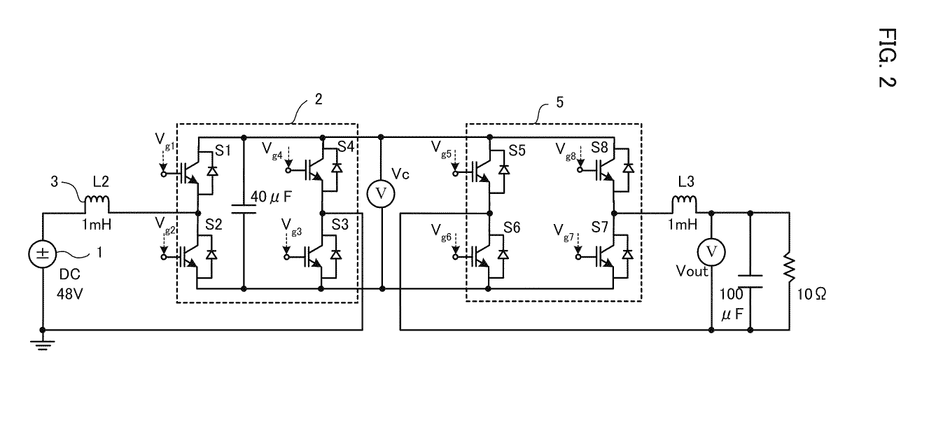

FIG. 2 shows a circuit diagram of assistance in explaining operation of the synchronous motor drive power supply apparatus according to the present invention. FIG. 2 shows a case of converting direct-current to single-phase alternating-current for convenient description. An MERS 2 is connected in series to a direct-current power source 1 and a reactor 3. The MERS 2 is constituted with four reverse conductive semiconductor switches S1 to S4 and a capacitor 9. The synchronous motor drive power supply apparatus has control means 7 (not shown) of reverse conductive semiconductor switches S1 to S8. The control means 7 turns on and off the reverse conductive semiconductor switches S1 to S8 in synchronization with the rotation of a synchronous motor 4, so that direct-current pulse voltage higher than the voltage of the direct-current power source 1 is generated at the capacitor 9. Rectangular wave current is generated with the direct-current pulse voltage. In FIG. 2, pulse current of 200 Hz in a degree of single-phase AC 200 V is generated at a resistance load (10Ω) with the direct-current power source 1 of 48 V.

The MERS 2 serving as the function of the pulse voltage generating means 2 constituted with the four reverse conductive semiconductor switches S1 to S4 is connected to the direct-current power source 1 via the reactor 3 so as to become a power source forming a loop (or to become a circulation path returning from the direct-current power source 1 to the direct-current power source 1 not via the load). When the control means 7 simultaneously turns on the reverse conductive semiconductor switches S2 and S4, magnetic energy is stored in the reactor 3 more than a typical flyback circuit due to flow of discharge current of the capacitor 9 to the direct-current power source 1 in a forward direction. Next, when the control means 7 simultaneously turns off the reverse conductive semiconductor switches S2 and S4, charging voltage is generated at the capacitor 9 and the voltage of the capacitor 9 is increased until the magnetic energy of all the inductances existing in the circuit is stored in the capacitor 9 in the form of electrostatic energy possessed by electric charge.

As shown in FIG. 2, when the switch element is the reverse conductive semiconductor switch, the magnetic energy stored in a smoothing inductor 8 connected to the polarity switching means 5 can also be recovered to and stored in the capacitor 9 in the form of electrostatic energy possessed by electric charge. As the polarity switching means 5 being the second MERS circuit (in the state that two pieces of MERS 2 are present) in addition to voltage rise due to the MERS 2 and voltage rise due to the polarity switching means 5, higher voltage than voltage rise only due to the MERS 2 is generated at the capacitor 9. Then, more energy can be derived from the direct-current power source 1 as the discharging current of the capacitor 9 flows back to the direct-current power source 1.

In the synchronous motor drive power supply apparatus according to the present invention, since all the reverse conductive semiconductor switches are switched on at approximately zero current and are switched off at approximately zero voltage, switching loss can be reduced. Accordingly, the present invention is relevant to a drive power supply apparatus capable of driving a synchronous motor at high frequency, that is, of driving the motor at high speed.

When the synchronous motor 4 is driven by the synchronous motor drive power supply apparatus according to the present invention, for instance, by converting current polarity of the direct-current pulse voltage from the pulse voltage generating means 2 into six-phase alternating-current by the polarity switching means 5, the control means 7 can smoothly rotate the synchronous motor 4.

Inversion which recovers the counter-electromotive force of the synchronous motor 4 to the direct-current power source 1 can be performed with switching of the pair of reverse conductive semiconductor switches S1 and S3 of the MERS 2 instead of the pair of reverse conductive semiconductor switches S2 and S4 of the MERS 2. In the synchronous motor drive power supply apparatus according to the present invention, since the voltage of the direct-current power source 1 is low, voltage control is performed at chopper control of the counter-electromotive force of the synchronous motor 4 using the pair of reverse conductive semiconductor switches S1 and S3 of the MERS 2. Accordingly, inversion can be performed until lower rotational speed of the synchronous motor 4 compared to a typical voltage type inverter.

### EMBODIMENTS

### First Embodiment

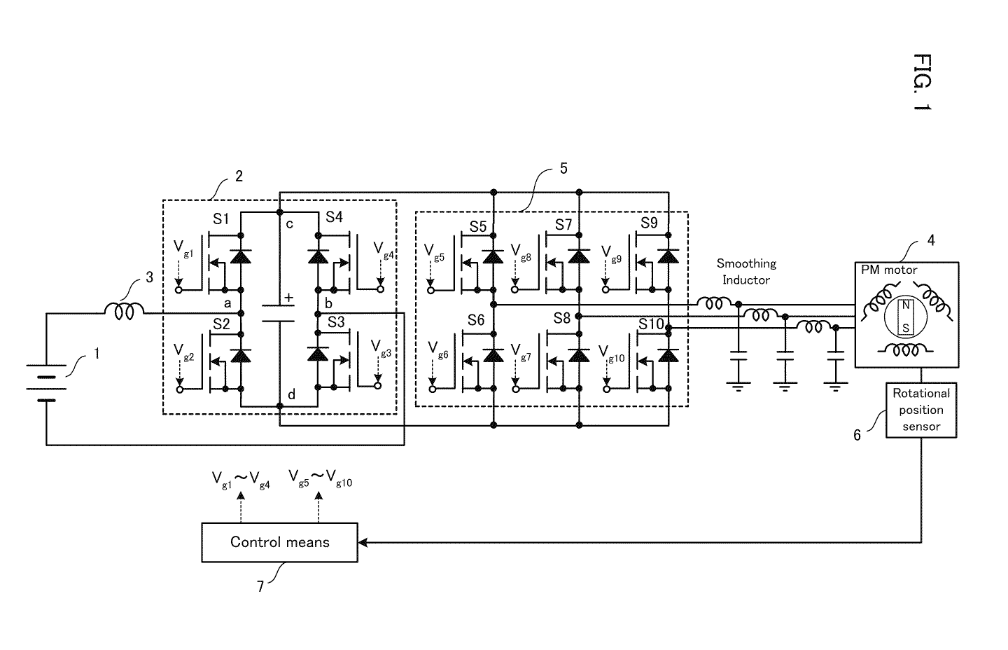

FIG. 1 is a circuit block diagram (hereinafter, called a circuit diagram) showing a first embodiment of a synchronous motor drive power supply apparatus according to the present invention (hereinafter, called the present apparatus). In the first embodiment, the synchronous motor 4 is assumed as a three-phase permanent-magnet synchronous motor. In the present apparatus, the direct-current power source 1, the MERS 2 constituted with the four reverse conductive semiconductor switches S1 to S4 and the capacitor 9, and the reactor 3 are connected in series, and the direct-current pulse voltage generated at the MERS 2 is supplied to each phase of the synchronous motor 4 via the polarity switching means 5.

Further, the present apparatus includes the control means 7 to control ON/OFF of the reverse conductive semiconductor switches S1 to S10. The control means 7 performs switching control at the switching frequency Fs higher than the frequency Fm of counter-electromotive force of the synchronous motor 4.

As expressed by the following equation 1, the switching frequency Fs is preferably to be twice of the frequency Fm of the counter-electromotive force or higher for the synchronous motor 4 of a single-phase type and to be integral multiple of six times of the frequency Fm of the counter-electromotive force for the synchronous motor 4 of a three-phase type.

Fs=n×Fm n=2, 3, (Equation 1)

More specifically, the control means 7 performs switching of the reverse conductive semiconductor switches S1 to S4 constituting the MERS 2 by an ON/OFF signal at a duty corresponding to direct-current pulse voltage or output of synchronous motor input to generate pulsed voltage at the capacitor 9.

Further, the control means 7 performs switching of the reverse conductive semiconductor switches S5 to S10 constituting the polarity switching means 5 by synchronizing the gate signal synchronized with the frequency Fm of the counter-electromotive force of the synchronous motor 4 and the signal of the switching frequency Fs, so that higher voltage than the voltage of the direct-current power source 1 can be supplied to the synchronous motor 4.

The control means 7 generates the frequency Fm of the counter-electromotive force of the synchronous motor 4 based on a signal from a rotational position sensor 6 of the synchronous motor 4. The rotational position sensor 6 may be a type such as a magnetic sensor type using a hall element and a rotary encoder type.

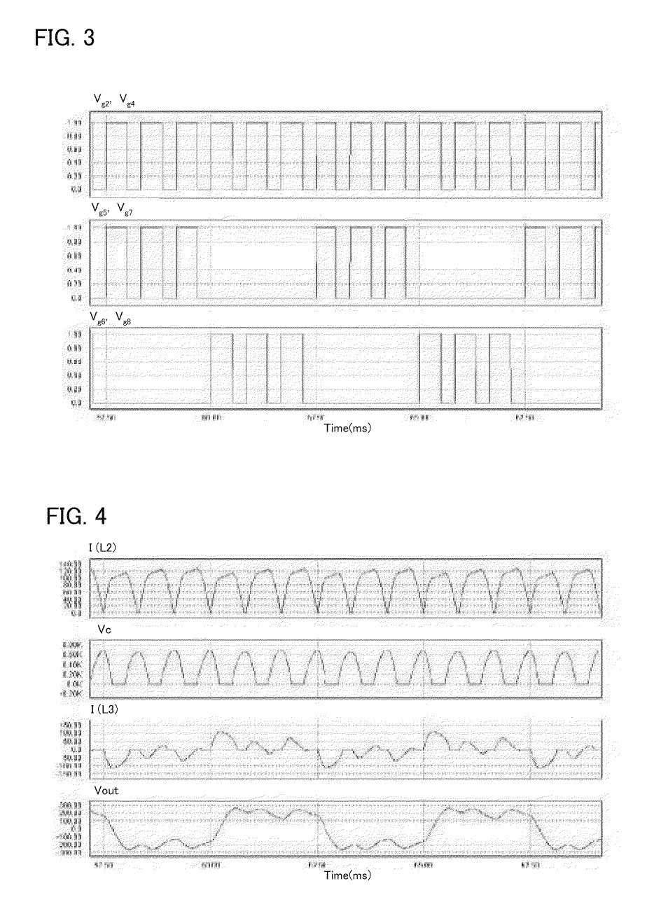

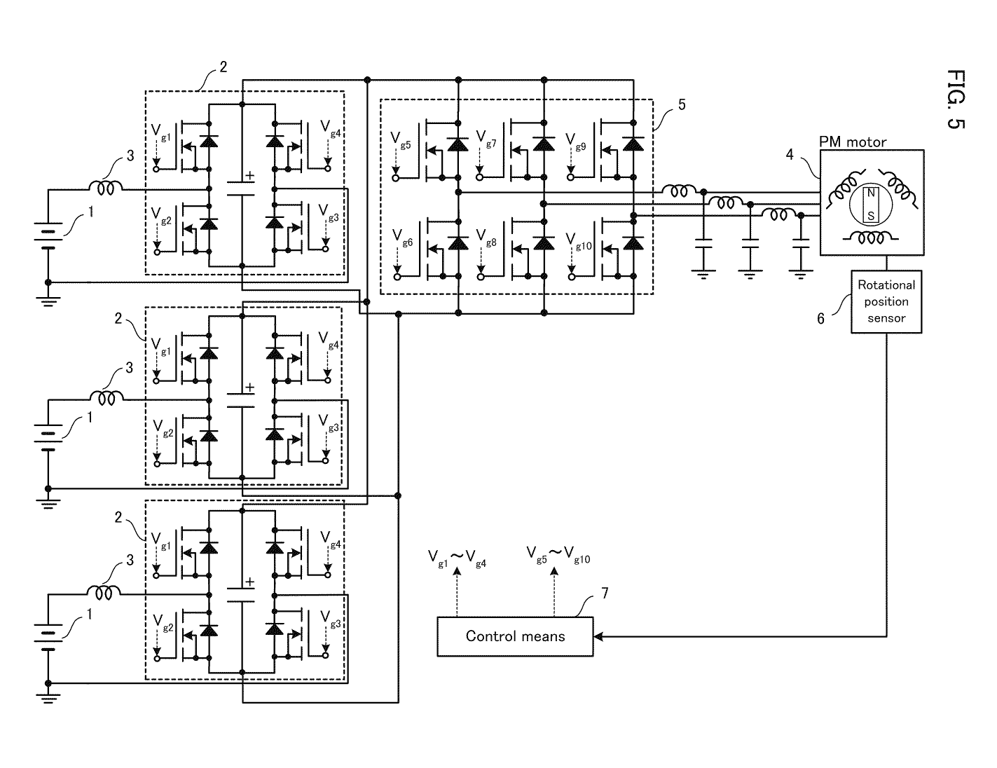

FIG. 2 is a circuit diagram for confirming fundamental operation of the first embodiment. FIGS. 3 to 4 show simulation results of FIG. 2. The circuit constants of the simulation of FIGS. 3 and 4 are as follows.

1. Direct-current power source 1: 48 V
2. Resistance load 11: 10Ω

### 3. Reactor 3: 1 mH

### 4. Capacitor 9: 40 μF

5. Reverse conductive semiconductor switches S1 to S8: IGBT (insulated gate bipolar transistor)
6. Smoothing inductor 8: 1 mH
7. Smoothing capacitor 10: 100 μF

The control means 7 supplies a signal to turn on and off the gate (hereinafter, called a gate signal) of the reverse conductive semiconductor switches S1 to S8 to the reverse conductive semiconductor switches S1 to S8. Further, the control means 7 varies duty and phase of the gate signal in synchronization with the switching frequency Fs for generating direct-current pulse voltage and the frequency Fm of the counter-electromotive force of the synchronous motor 4 and according to direct-current pulse voltage generated at the capacitor 9 and output for the synchronous motor input.

In FIG. 2, for convenience of simulation analysis, it is assumed that the synchronous motor 4 is the resistance load 11 (pure resistance). To smooth output of the polarity switching means 5, the smoothing capacitor 10 and the smoothing inductor 8 are connected. The switching frequency Fs for generating the direct-current pulse voltage is 1200 Hz, and ON-time is 500 μsec (a duty ratio is 0.6). In addition, the frequency Fm of the counter-electromotive force of the synchronous motor 4 is 200 Hz.

FIGS. 3(a) to 3(c) show gate signals of the reverse conductive semiconductor switches S2 and S4 to S8. More specifically, FIG. 3(a) shows a gate signal Vg2 of the reverse conductive semiconductor switch S2 and a gate signal Vg4 of the reverse conductive semiconductor switch S4 (the Vg2 and Vg4 are the same signal), FIG. 3(b) shows a gate signal Vg5 of the reverse conductive semiconductor switch S5 and a gate signal Vg7 of the reverse conductive semiconductor switch S7 (the Vg5 and Vg7 are the same signal), and FIG. 3(c) shows a gate signal Vg6 of the reverse conductive semiconductor switch S6 and a gate signal Vg8 of the reverse conductive semiconductor switch S8 (the Vg6 and Vg8 are the same signal). The present invention has a feature that all of the gate signals are synchronized with the switching frequency Fs. From FIGS. 3(a) to 3(c), it can be seen that the control means 7 turns on and off the reverse conductive semiconductor switches S5 to S8 of the polarity switching means 5 in synchronization with the switching frequency Fs, and alternately allocates (replaces) the gate signals to turn on the reverse conductive semiconductor switches in synchronization with the frequency Fm of the counter-electromotive force of the synchronous motor 4 to the pair of reverse conductive semiconductor switches (S5, S7) or the pair of reverse conductive semiconductor switches (S6, S8). FIGS. 3(b) and 3(c) show the gate signals of the reverse conductive semiconductor switches assuming that direct-current is converted to single-phase alternating-current. When direct-current is converted to three-phase alternating-current, the gate signals to turn on the reverse conductive semiconductor switches are phase shifted every 120 degrees.

FIGS. 4(a) to 4(d) show simulation results of the circuit diagram shown in FIG. 2. More specifically, FIG. 4(a) shows current Iin flowing through the reactor 3, FIG. 4(b) shows end-to-end voltage Vc of the capacitor 9, FIG. 4(c) shows current (output current) Iout flowing through the smoothing inductor 8, and FIG. 4(d) shows end-to-end voltage (output voltage) Vout of the resistance load 11.

The reverse conductive semiconductor switches are switched at zero current and zero voltage to realize soft switching.

From FIG. 4(b), in the end-to-end voltage Vc of the capacitor 9, voltage over 600 V is generated at maximum.

From FIGS. 4(b) and 4(c), the current Iout flowing through the smoothing inductor 8 becomes approximately zero when the end-to-end voltage Vc of the capacitor 9 is at a peak. This fact shows that the magnetic energy stored in the smoothing inductor 8 is recovered to the capacitor 9 in the form of electrostatic energy possessed by electric charge.

From FIG. 4(d), it can be seen that the voltage of 200 Vrms is supplied to the resistance load 11. In addition, the output current Iout is smoothed by the smoothing capacitor 10. The output power of the circuit shown in FIG. 2 is about 4 kW.

### Second Embodiment

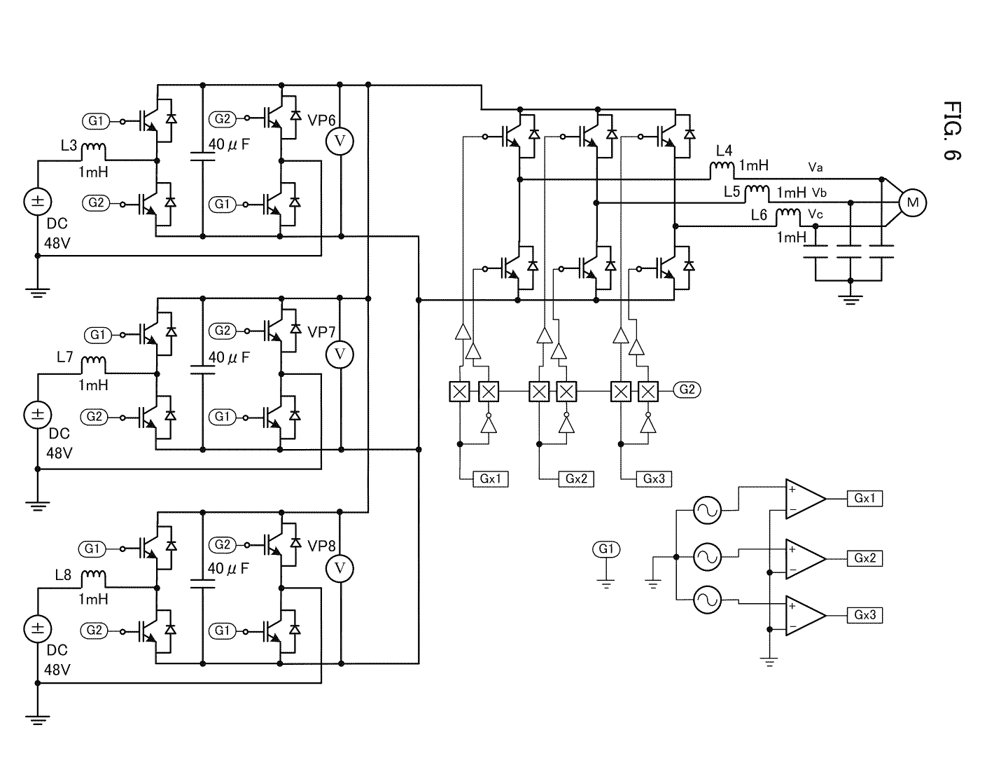

FIG. 5 is a circuit diagram showing a second embodiment of the present apparatus. In the second embodiment of the present apparatus, a battery is assumed as the direct-current power source 1, and three pairs of batteries and the pulse voltage generating means with the MERS 2 are connected in parallel. Further, FIG. 5 exemplifies the three pairs of batteries and pulse voltage generating means with the MERS 2. A number of MERS 2 are connected in parallel, so that the number of batteries are connected in parallel shunted by the reactors 3. By connecting low-voltage batteries in parallel, a large-current battery can be obtained as a whole even though each battery is not a large-current type. Accordingly, it is possible to expect that safety is maintained in a stopped state of the present apparatus.

FIG. 6 is a simulation circuit diagram of FIG. 5. In FIG. 6, a separately-excited synchronous motor having a magnetic exciting circuit is assumed instead of the synchronous motor 4. Circuit constants of FIG. 6 are the same as the simulation of FIG. 2.

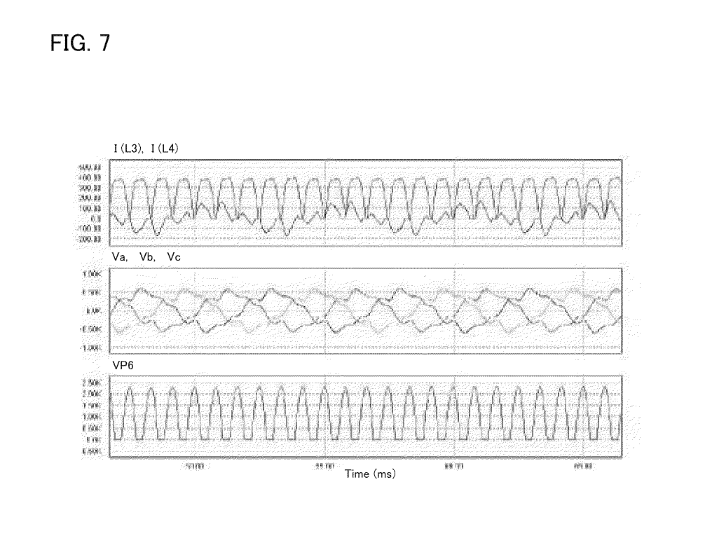

FIGS. 7(a) to 7(c) show simulation results of FIG. 6. More specifically, FIG. 7(a) shows current I (3a) flowing through a reactor 3a and current I (8a) flowing through a smoothing inductor 8a, FIG. 7(b) shows input voltages (Va, Vb, Vc) of respective phases (a-phase, b-phase, c-phase) of the synchronous motor 4, and FIG. 7(c) shows end-to-end voltage Vc1 of a capacitor 9a of an MERS 2a.

From FIG. 7(a), the current I (3a) flowing through the reactor 3a is about 400 A at a peak, and from FIG. 7(b), the voltage of respective phases is 350 Vrms at 200 Hz. From FIG. 7(c), the end-to-end voltage Vc1 of the capacitor 9a is about 2300 V at maximum. That is, voltage of about 2300 V can be obtained from the battery of 48 V.

### DESCRIPTION OF REFERENCE NUMERALS

1, 1a, 1b, 1c Direct-current power source
2, 2a, 2b, 2c Pulse voltage generating means (MERS)
3, 3a, 3b, 3c Reactor
4 Synchronous motor
5 Polarity switching means
6 Rotational position sensor
7 Control means
8, 8a, 8b, 8c Smoothing inductor
9, 9a, 9b, 9c (Resonance) capacitor
10, 10a, 10b, 10c Smoothing capacitor
11 Resistance load
S1, S2, S3, S4, S5, S6, S7, S8 Reverse conductive semiconductor switch

1. A PM motor drive power supply apparatus which drives a permanent-magnet synchronous motor (hereinafter, called a PM motor) having N pieces of phases (N is a positive integer being three or larger) by utilizing a direct-current power source (1), comprising:
pulse voltage generating means (2) which receives input at alternating-current input terminals (a, b) via a reactor (3) from the direct-current power source (1);
polarity switching means (5) which is connected to direct-current output terminals (c, d) of the pulse voltage generating means (2) and which supplies pulse voltage generated at the pulse voltage generating means (2) to the PM motor as alternating-current by switching for each phase of the PM motor;
a smoothing inductor to smooth output of the polarity switching means (5),
a rotational position sensor (6) to detect a rotational position of the PM motor (4) and to output a rotational position signal; and
control means (7) to perform ON/OFF control of switches of the pulse voltage generating means (2) and the polarity switching means (5);
wherein the pulse voltage generating means (2) includes four reverse conductive semiconductor switches (S1, S2, S3, S4) mutually connected as a bridge and a capacitor connected to the direct-current output terminals (c, d) of the bridge to recover and store magnetic energy of current at the time of current interruption; and
the control means (7) controls to simultaneously perform ON/OFF operation of a diagonally positioned pair among the reverse conductive semiconductor switches (S1 to S4) of the pulse voltage generating means (2), controls to perform ON/OFF operation of switches of N lines of the polarity switching means (5) at the same timing as the reverse conductive semiconductor switches (S1 to S4) of the pulse voltage generating means (2), selects a switch of the polarity switching means (5) based on the rotational position signal, converts direct-current pulse output of the pulse voltage generating means (2) into polarities of the N-phase alternating-current, and supplies to the PM motor (4) as drive current.

2. The PM motor drive power supply apparatus according to claim 1,
wherein soft switching as being zero voltage when the reverse conductive semiconductor switch is turned off and being zero current when the reverse conductive semiconductor switch is turned on is actualized as voltage of the capacitor is discharged to be zero for each period by setting ON/OFF period length of the reverse conductive semiconductor switch to be longer than resonance period length which is determined by electrostatic capacitance of the capacitor and inductance of the reactor (3).

3. The PM motor drive power supply apparatus according to claim 1,
wherein the polarity switching means (5) is constituted with 2N pieces of reverse conductive semiconductor switches and recovers and stores magnetic energy of inductance on the circuit into the capacitor when the reverse conductive semiconductor switch is turned off.

4. The PM motor drive power supply apparatus according to claim 1,
wherein plural sets are connected in parallel, each set being constituted with the direct-current power source (1), the pulse voltage generating means (2) and the reactor (3).

5. The PM motor drive power supply apparatus according to claim 1,
wherein recovery charging of the direct-current power source is performed as the direct-current power source being a battery, control sequence of the control means (7) being reversed, and the PM motor being a generator.

6. The PM motor drive power supply apparatus according to claim 2,
wherein the polarity switching means (5) is constituted with 2N pieces of reverse conductive semiconductor switches and recovers and stores magnetic energy of inductance on the circuit into the capacitor when the reverse conductive semiconductor switch is turned off.

7. The PM motor drive power supply apparatus according to claim 2,
wherein plural sets are connected in parallel, each set being constituted with the direct-current power source (1), the pulse voltage generating means (2) and the reactor (3).

8. The PM motor drive power supply apparatus according to claim 3,
wherein plural sets are connected in parallel, each set being constituted with the direct-current power source (1), the pulse voltage generating means (2) and the reactor (3).

9. The PM motor drive power supply apparatus according to claim 6,
wherein plural sets are connected in parallel, each set being constituted with the direct-current power source (1), the pulse voltage generating means (2) and the reactor (3).

10. The PM motor drive power supply apparatus according to claim 2,
wherein recovery charging of the direct-current power source is performed as the direct-current power source being a battery, control sequence of the control means (7) being reversed, and the PM motor being a generator.

11. The PM motor drive power supply apparatus according to any claim 3,
wherein recovery charging of the direct-current power source is performed as the direct-current power source being a battery, control sequence of the control means (7) being reversed, and the PM motor being a generator.

12. The PM motor drive power supply apparatus according to any claim 4,
wherein recovery charging of the direct-current power source is performed as the direct-current power source being a battery, control sequence of the control means (7) being reversed, and the PM motor being a generator.

13. The PM motor drive power supply apparatus according to any claim 6,
wherein recovery charging of the direct-current power source is performed as the direct-current power source being a battery, control sequence of the control means (7) being reversed, and the PM motor being a generator.

14. The PM motor drive power supply apparatus according to any claim 7,
wherein recovery charging of the direct-current power source is performed as the direct-current power source being a battery, control sequence of the control means (7) being reversed, and the PM motor being a generator.

15. The PM motor drive power supply apparatus according to any claim 8,
wherein recovery charging of the direct-current power source is performed as the direct-current power source being a battery, control sequence of the control means (7) being reversed, and the PM motor being a generator.

16. The PM motor drive power supply apparatus according to any claim 9,
wherein recovery charging of the direct-current power source is performed as the direct-current power source being a battery, control sequence of the control means (7) being reversed, and the PM motor being a generator.
